(19) United States
(12) Patent Application Publication
(10) Pub. No.: US 2008/0046578 A1
(43) Pub. Date: Feb. 21, 2008

(54) Controlled access to a video recording over an IP multimedia subsystem, IMS, telecommunications network

(76) Inventor: Tjietse van der Gaast, Huizen (NL)

Correspondence Address: Lucent Technologies Inc.;Docket Administrator, Room 3J-219, 101 Crawfords Corner Road, Holmdel, NJ, 07733-3030, US

(21) Appl. No.: 11/505,011

(22) Filed: Aug. 16, 2006

(51) Int. Cl. G06F 15/16

(52) U.S. Cl. 709/229; 709/217

(57) ABSTRACT

A telecommunications network is provided comprising a server and a database. The server is configured to store a video recording made by an authenticated first user terminal in the database. The server is configured to control access to that video recording by user terminals according to a predetermined rule selected by the user of the first user terminal. The network is an Internet Protocol, IP, Multimedia Subsystem, IMS, network. The network is configured to authenticate a user terminal making a request to store or access the video recording by querying a home subscriber server, HSS.

### FIELD OF THE INVENTION

The present invention relates to telecommunications, particularly, but not exclusively, to wireless telecommunications.

### DESCRIPTION OF THE RELATED ART

Known related art falls into two separate categories. On the one hand, there is transfer of digital recordings onto a web-server for access by others. On the other hand, there is known Internet Protocol Multimedia Subsystem, IMS.

As regards transfer of digital recordings onto a web-server for access by others, the video recording is stored in the memory of a video camera, and then transferred via personal computer to a web-server. The video camera may be part of a user terminal, such as a mobile phone.

Turning now to the other area of related art, IP Multimedia Subsystem, IMS, this is a Next Generation Networking, NGN, standard for telecommunications networks that provide Voice over Internet Protocol, VoIP, and multimedia services. IMS relies on Session Initiation Protocol, SIP, and standard Internet Protocol, IP. Session Initialisation Protocol, SIP, is standardised by the Internet Engineering Task Force, IETF, enhanced by the Third Generation Partnership Project, 3GPP, Third Generation Partnership Project 2, 3GPP-2, and European Telecommunications Standards Institute, ETSI, Telecoms & Internet converged Services & Protocols for Advanced Networks, TISPAN (ETSI TISPAN).

IMS was defined in Release 5 (evolution from 2G to 3G wireless networks) of 3GPP standards. In subsequent releases of the standard, some additional features were added, namely interworking with wireless local area networks, WLAN, in Release 6, and support for fixed networks in Release 7.

IMS enables registered user terminals to set up communication sessions with other user terminals or remote servers using Session Initialisation Protocol, SIP. Basic (e.g. voice) communications can be enhanced by additional services. An example of such an additional service is voice mail service. Users gain access to the additional services either by default as users of the network, or by subscription.

The additional services are implemented in application servers. An application server can, of course, be an end point for a communication session with a user terminal.

In a known IMS network, the application server communicates with a Home Subscriber Server, HSS, which stores information about user terminals. This information includes user profiles as to services to which particular users subscribe, information as to which users are registered as its “home” users and where they are currently located, and also authorisation/authentication status of particular users.

As shown in FIG. 1, the known network 2′ includes an Internet protocol (IP) Multimedia Subsystem, IMS 4′. The IMS consists essentially of an IMS core network 6′ made up of a home subscriber server, HSS 8′, a Call Session Control Function, CSCF, 10′, and an application server 12′.

A service, such as voice mail, is provided by the application server 12′ to the user terminal 14′, often referred to as a User Equipment and denoted UE. The CSCF 10′ controls a call and, for that purpose, communicates with both the application server 12′ and user terminal 14′ using Session Initialisation Protocol, SIP. The application server 12′ communicates with the home subscriber server, HSS 8′, which stores data about users, in order to authenticate the user terminal 14′ and for billing purposes. These communications with the home subscriber server, HSS 8′ are made via an interface known as the Sh interface using Diameter protocol.

As shown in FIG. 1, the UE 14′ uses SIP for its control message communications with the CSCF 10′, and uses Real Time Protocol, RTP, for transport of data packets to/from the application server 12′.

### SUMMARY OF THE INVENTION

The inventor found a way to allow controlled access to a subscriber's video recordings over a telecommunications network.

An example of the present invention is a telecommunications network. The network comprises a server and a database. The server is configured to store a video recording made by an authenticated first user terminal in the database. The server is configured to control access to that video recording by user terminals according to a predetermined rule selected by the user of the first user terminal. The network is an Internet Protocol, IP, Multimedia Subsystem, IMS, network. The network is configured to authenticate a user terminal making a request to store or access the video recording by querying a home subscriber server, HSS.

By using the home subscriber server, HSS, to authenticate subscribers, effective access control to video recordings can be readily undertaken. Video recordings of a subscriber are often of a sensitive and personal nature, at least to that subscriber, such that rigorous yet efficient access control is advantageous.

As compared to known uploading to a web-server from a digital camera, users can enjoy better Quality of service in handling video, and better protection against viruses, as the server controlling access is in accordance with IMS protocols. Also, the user is not required to have videotapes or videodisks.

### BRIEF DESCRIPTION OF THE DRAWINGS

Embodiments of the present invention will now be described by way of example and with reference to the drawings, in which:

FIG. 1 is a diagram illustrating a known network (PRIOR ART)

FIG. 2 is a diagram illustrating a network according to a first embodiment of the present invention,

FIG. 3 is a diagram illustrating in more detail the application server shown in FIG. 2, (apparatus that is shown in FIG. 2 to which the application server is connected is also shown in FIG. 3),

FIG. 4 is a diagram illustrating in more detail the user terminal shown in FIG. 2,

FIG. 5 is a diagram illustrating a network according to a second embodiment of the present invention, and

FIG. 6 is a diagram illustrating in more detail the user terminal shown in FIG. 5.

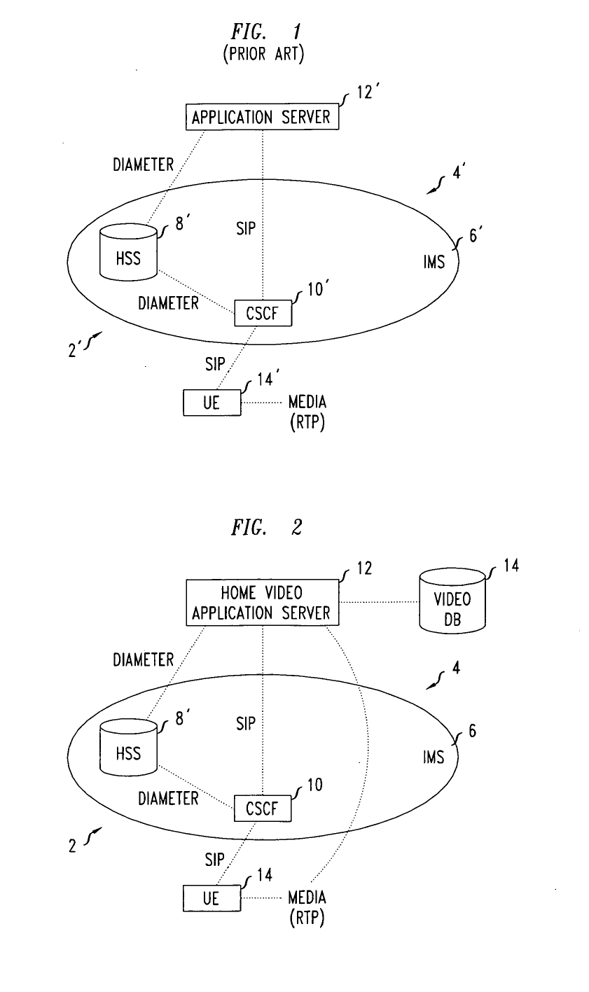

### DETAILED DESCRIPTION

The inventor realised that it would be useful to dedicate an IMS application server to the storage and retrieval of video recordings of end users. Appropriate querying of the home subscriber server, HSS, would then readily facilitate selective access to those video recordings. Video recordings can include audio, so as to be audiovisual recordings, and can be, for example, short video clips or a sequence of two or more such clips.

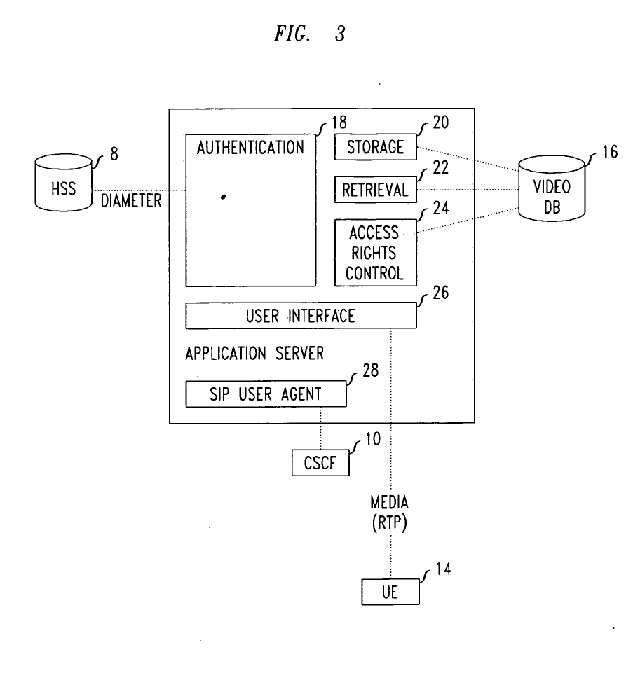

As shown in FIG. 2, a network 2 includes an Internet protocol (IP) Multimedia Subsystem, IMS 4. The IMS 4 consists essentially of an IMS core network 6 made up of a home subscriber server, HSS 8, a Call Session Control Function 10, CSCF, and an application server 12. The application server 12 provides a video service (described in more detail below) to the user terminal 14, often referred to as a User Equipment denoted UE. The CSCF 10 communicates with both the application server 12 and user terminal 14 using Session Initialisation Protocol, SIP. The application server 12 communicates with the home subscriber server, HSS 8, which stores data about users, in order to authenticate the user terminal 14 and for billing purposes. These communications with the home subscriber server, HSS 8 are via an interface known as the Sh interface using known Diameter protocol.

As shown in FIG. 2, the UE 14 uses SIP for its control message communications with the CSCF 10, and uses Real Time Protocol, RTP, for transport of data packets to/from the application server 12.

### Home Subscriber Server

The home subscriber server, HSS 8, can be considered as a master user database that supports the IMS network entities, namely the CSCF 10 and application server 12, that actually handle calls/sessions. The HSS 8 contains subscription-related information (user profiles) useful for performing authentication of the user terminal, and can also provide information as to the physical location of a user terminal.

The HSS 8 is aware of the current locations of its “home” users and re-routes incoming SIP invitation messages to the appropriate visitor network (not shown) if the home user addressed is currently roaming.

### Application Server

As shown in FIGS. 2 and 3, the application server 12 is an application server dedicated to the active storage and retrieval of video recordings, hence denoted a home video application server in FIG. 2. The server 12 is connected to a video database 16. The application server enables storage of digital video recordings for each subscriber and controls access to the video recordings of each subscriber by other subscribers.

As shown in FIG. 3, the application server is a processor consisting of a user interface 26, an authentication stage 18, a storage interface 20, a retrieval interface 22, an access control stage 24, and a SIP User Agent 28. These components are explained in more detail below.

### User Interface

As shown in FIG. 3, in the application server 12, the user interface enables interaction with the user. Specifically, the user interface presents subscribers with a menu of options, for example, to record, playback, enable/disable access to particular subscribers or classes of subscribers etc. The menu options are provided to the subscriber's terminal 14 in recorded-speech form, and also in picture icons and/or written word form for display by those subscriber terminals having a visual display screen.

The user interface 26 optionally includes an editing function capable of adding titles, background music etc to video. The editing function allows automated creation of a movie-type sequence of video from video material, according to preset background theme music options and pre-programmed editing styles (fast cuts for action, slow panning for romantic etc). The editing function also allows subscriber's digital still photographs to be added. The editing function applies image stabilisation and noise reduction of known type.

### Authentication Stage

In the application server 12, the authentication stage 18 is operative to check the identity of a user terminal as being one that subscribes to the service. This is achieved by the authentication stage 18 communicating with the home subscriber server, HSS 8, using Diameter protocol. Once authentication is complete and successful in respect of the user terminal, the authentication stage 18 communicates with the storage interface 20 if the authenticated subscriber requests storage of a video recording. Alternatively, if the user terminal is requesting certain video data, the authentication stage 18 communicates with the access control stage 24 that then determines whether to grant access to that data.

### Storage Interface

The storage interface 20 of the application server 12 facilitates the recording of video clips in the video database 16. The storage interface 20 electronically tags the video recordings received from a subscriber for storage with identifiers of date, time, location, subscriber identity, and subscriber's video content descriptor. The tags can be visible on the video recordings, e.g. date and time, or otherwise, according to the subscriber's preferences as provided from the user interface 26. The storage interface 20 can process video recording before storage according to subscriber's simple instructions, for example adding an automated summary, compiling a sequence of separate clips together, adding mood music etc.

### Retrieval Interface

The retrieval interface 22 of the application server 12 handles the retrieval and playback of digital video data, such as video clips, that are stored in the video database 16.

### Access Control Stage

In the application server 12, the access control stage 24 enables a subscriber to control access to the video data stored in the video database 16 associated with his/her subscriber identifier. Specifically, this includes the video data that the subscriber himself/herself has stored.

The access control stage has records of which subscribers have access to what video recording data. If a request for access is acceptable, the access control stage 24 controls the retrieval interface 22 to allow access.

The subscriber selects between various access control options. For example, the subscriber can elect to allow access only to that subscriber himself. Alternatively the subscriber can elect to allow a limited number of subscribers who are individually identified by their telephone numbers or Session Initialisation Protocol, SIP, Universal Resource Identifiers, URIs. SIP URIs can be considered as the SIP equivalent to telephone numbers.

Another option is for the subscriber to elect to allow access to a whole group or class of subscribers, for example all those with a URI domain. A further option is for the subscriber to elect to allow access to all subscribers.

If the subscriber wishes to change his selection, he can achieve this by appropriate use of menus on his user terminal 14 causing SIP messaging via CSCF 10 to the application server 12.

### Session Initialisation Protocol, SIP, User Agent

The Session Initialisation Protocol, SIP, User Agent 28 in the application server 12 manages SIP signalling to and from the user terminal 14 and the Call Session Control Function, CSCF 10.

### User Terminal

As shown in FIG. 4, the user terminal 14 includes a transmitter 30 and receiver 32 of known type such as in accordance with General Packet Radio Service, GPRS systems (known in the Global System for Mobiles, GSM, systems) or High Speed Data Packet Access, HSDPA, systems. The user terminal 14 also includes input and output devices for video and audio, specifically an integral digital video camera 34, a microphone 36, a keypad 38 and a display screen 40. The user terminal 14 also includes its own a Session Initialisation Protocol, SIP, User Agent 42. This user agent 42 is operative to manage SIP signalling via the transmitter 30 and/or receiver 32 with the Call Session Control Function, CSCF of the IMS system.

UE 14 uses SIP for its control message communications with the CSCF 10, and uses Real Time Protocol, RTP, for transport of data packets to/from the application server 12.

### Operation

In use, a user terminal 14 of a subscriber registered with the application server 12 is authenticated by the authentication stage 18 of the application server 12. This is done by appropriate querying of the home subscriber server, HSS, and communications with the user terminal 14 via the CSCF 10.

Upon being successfully authenticated, the user terminal 14 is allowed to transmit the video data using Real Time Protocol, RTP, to the user interface 26 of the application server 12. From there, it is forwarded by the storage stage 20 of the application server 12 to the video database 16 where it is stored with the identity of the subscriber as an identifier for access control purposes. The server tags the video recordings received from a subscriber with data, time, location, subscriber identity, and subscriber's video content descriptor.

This so-called uploading of video data to the video database 16 is done, selectably by the subscriber, either in real-time or non-real time (i.e. at a lower rate than necessary for a real time video sequence), either immediately as the video is recorded by the user terminal 14 or afterwards, for example at times of low network loading (when a connection cheaper to the user is likely). In this example, only the subscriber himself is permitted to store video data associated with his subscriber identity. This can be considered as a restricted write-access.

As regards retrieval of stored video for playback or further processing, a user terminal 14 can request video retrieval via the CSCF 10 to the application server 12. First the user terminal is authenticated by the authentication stage 18 of the application server 12 communicating with the home subscriber server, HSS 8. Second, if authentication is successful, a check is made as to whether the request is in accordance with the access control rules defined in the access control stage. If so, then access is enabled and the video is retrieved by the retrieval stage 22 and sent to the user interface 26 and then on to the user terminal 14.

### Variants

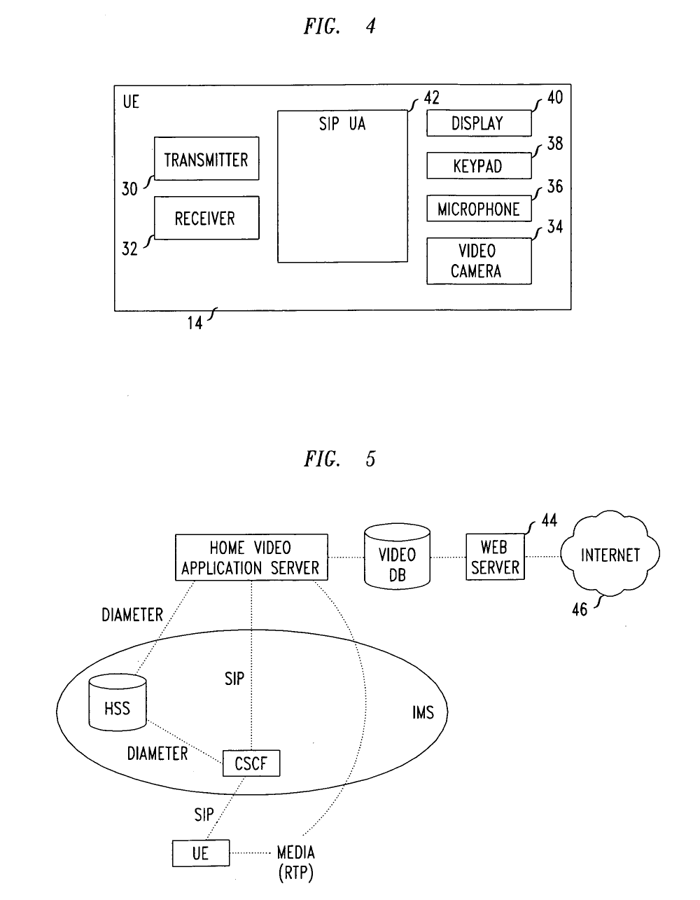

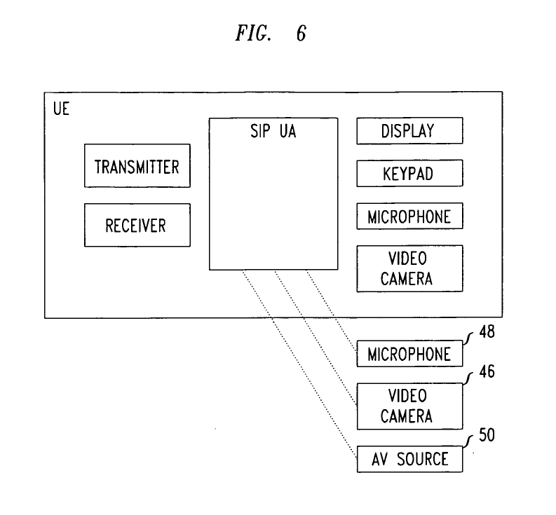

Another embodiment is shown in FIG. 5. This is as shown and described in relation to FIGS. 2 to 4, save that the video database is additionally accessible via a webserver 44 to the internet 46. This is particularly useful for video intended to be distributed widely.

In that or some other embodiments, as shown in FIG. 6 the user terminal additionally has external devices connected, such as a camera 46 for higher resolution video, higher quality microphone 48, or other audiovisual data source 50.

User terminals can be user terminals for wireless telecommunications. In some embodiments, at least some user terminals can be terminals for wired telecommunications (i.e. terminals that are wired in the sense of being for connection to the network by wire), such as IMS Internet Protocol Television, IMS IPTV, terminals. For uploading video recordings, the terminals might more commonly be wireless. For viewing video recordings, the terminals may more commonly be wired.

In some embodiments, the home subscriber server, HSS, is broadly similar to a home local register (HLR) and authentication center (AuC) of known Global System of Mobiles, GSM, networks.

In some embodiments, video data can be stored associated with one subscriber by another subscriber, for example a trusted family member.

In some embodiments, the application server receives comments from subscribers who see the video recordings, such as friends, and superimposes those comments onto video pictures or adds the comments as audio or additional audio to the video sequence.

In some embodiments, the application server records the identities of those subscribers that have requested access to a subscriber's video recordings, together with status information as to whether requesting subscribers were permitted access or not, and that information is supplied to the subscriber from time to time.

In some embodiments the application server records charges to subscribers for storage and/or retrieval of video recordings.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A telecommunications network,
the network comprising a server and a database,
the server being configured to store a video recording made by an authenticated first user terminal in the database and the server being configured to control access to that video recording by user terminals according to a predetermined rule selected by the user of the first user terminal,
the network being an Internet Protocol, IP, Multimedia Subsystem, IMS, network, and
the network being configured to authenticate a user terminal making a request to store or access the video recording by querying a home subscriber server, HSS.

2. A network according to claim 1, in which, in use, the predetermined rule is selectable by the user of the first user terminal from the following types of predetermined rules:
access only by the first user terminal,
access by any authenticated user terminal of a plurality of identified user terminals,
access by any authenticated user terminal of a specified group of user terminals,
access by any authenticated user terminal of any user of the network.

3. A network according to claim 2, in which, in use, access by any authenticated user terminal of a plurality of identified user terminals is provided by the user terminals being individually identified to the server configured to control access.

4. A network according to claim 3, in which at least some of the user terminals are individually identified to said server by their telephone numbers.

5. A network according to claim 3, in which at least some of the user terminals are individually identified to said server by their Session Initialisation Protocol, SIP, Universal Resource Identifiers, URIs.

6. A network according to claim 1, which is a network for wireless telecommunications.

7. A network according to claim 1, which is a network for wired telecommunications.

8. A network according to claim 1, which is a network for wireless and wired telecommunications.

9. A method of controlling access to a video recording in a telecommunications network, the method comprising:
the network authenticating a user terminal,
a processor receiving a video recording from the user terminal for storage in a database of video recordings,
the processor receiving an instruction from the user terminal of a rule as to which user terminals are authorised to receive the video recording,
the network authenticating a further user terminal,
the processor receiving a request from the further terminal for the video recording,
the processor determining whether the rule is met,
the processor accepting the request dependent upon the rule being met,
upon the request being accepted, the processor forwarding to the further user terminal the requested video recording,
in which the network is an Internet Protocol, IP, Multimedia Subsystem, IMS, network,
and in which a home subscriber server, HSS, is queried to authenticate the or each user terminal making a request for the video recording.

10. A method according to claim 9, in which the rule is selected by the user of the instructing user terminal from the following:
allow access only by that user,
allow access by any of a plurality of identified users,
allow access by any of a group of users,
allow access by any of all users of the network.
